(19) United States
(12) Patent Application Publication
(10) Pub. No.: US 2026/0362220 A1
(43) Pub. Date: Nov. 12, 2026

(54) MAPPING OF MULTIPLEXED MEDIA IDENTIFICATION INFORMATION BETWEEN A MEDIA APPLICATION FUNCTION AND NETWORK FUNCTIONS

(71) Applicant: InterDigital VC Holdings, Inc., Wilmington, DE (US)

(72) Inventors: Srinivas Gudumasu, Montreal (CA); Ahmed Hamza, Coquitlam (CA)

(73) Assignee: InterDigital VC Holdings, Inc., Wilmington, DE (US)

(21) Appl. No.: 19/205,740

(22) Filed: May 12, 2025

(51) Int. Cl. H04W 28/02; H04L 65/65

(52) U.S. Cl. CPC H04W 28/0268; H04L 65/65

(57) ABSTRACT

Systems, methods, and instrumentalities are disclosed for mapping multiplexed media identification information between a media application and network functions. A device may identify one or more identifiers associated with one or more media flows of an application flow of a protocol data unit (PDU) session. The device may send a request message including one or more sets of media identification information parameters associated with the one or more media flows. Each set of the one or more sets of media identification information parameters may indicate one of the one or more identifiers corresponding to a respective media flow. The request message may indicate a quality of service (QoS) rule and/or a charging policy to be applied to the respective media flow. The device may receive the one or more media flows based on the corresponding at least one of the QoS rule or the charging policy.

### BACKGROUND

Mobile communications using wireless communication continue to evolve. A fifth generation may be referred to as 5G. A previous (legacy) generation of mobile communication for example, may be fourth generation (4G) long term evolution (LTE).

### BRIEF SUMMARY

Systems, methods, and instrumentalities are disclosed for mapping multiplexed media identification information between a media application and network functions. A device (e.g., a wireless transmit/receive unit (WTRU) and/or an application server (AS)) may be provided including a processor. The device may identify one or more identifiers associated with one or more media flows of an application flow of a protocol data unit (PDU) session. The device may send, to a network, a request message including one or more sets of media identification information parameters associated with the one or more media flows. Each set of the one or more sets of media identification information parameters may indicate one of the one or more identifiers corresponding to a respective media flow. The request message may indicate at least one of a quality of service (QoS) rule or a charging policy to be applied to the respective media flow. The device may receive, from the network (e.g., the radio access network (RAN) node of the network), the one or more media flows based on the corresponding at least one of the QoS rule or the charging policy.

In examples, the one or more identifiers may be source description (SDES) real-time protocol (RTP) compact header extension identifiers or one or more media identifiers (MIDs) to be used in the PDU session. The device may be configured to identify the one or more identifiers using session description protocol (SDP). In examples, each set of the one or more sets of media identification information parameters may indicate at least one or more of: a synchronization source (SSRC) identifier to be used by an RTC endpoint, a payload type to be used by the RTC endpoint, an identification-tag or media identifier to be used by an RTC endpoint, a local identifier associated with one of the one or more media flow(s), or a real-time transport control protocol (RTCP) packet type. In examples, one of the SSRC identifier, the payload type, the identification-tag or media identifier, or the local identifier may be negotiated using session description protocol (SDP). In examples, the one or more sets of media identification information parameters may be included within an application flow description or media transport parameters property of the application flow description.

In examples, the request message may be sent to an application function (AF) of the network. In examples, the device (e.g., the WTRU) may receive one or more media flows via a radio access network (RAN) node of the network.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings.

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example quality of service (QoS) management in an example system (e.g., a 5G system).

FIG. 3 illustrates an example of multiplexed streams.

FIGS. 4A-4D illustrate various examples of generating multiplexed streams.

FIG. 5 illustrates an example of traffic over QoS flows where M SDF streams may be mapped to various QoS flows or N SDF streams may be mapped to a single QoS flow.

FIG. 6 illustrates an example of protocol data unit (PDU) set information associated with and/or carried in example QoS flows.

FIG. 7 illustrates an example of a one-byte header extension format for source description (SDES) items.

FIG. 8 illustrates an example of a two-byte header extension format for SDES items.

FIG. 9 illustrates an example of using session description protocol (SDP) for bundled media streams.

FIG. 10 illustrates a QoS flow mapping using a media identifier for packet filtering.

FIG. 11 illustrates a procedure for mapping multiplexed media to respective media streams.

### DETAILED DESCRIPTION

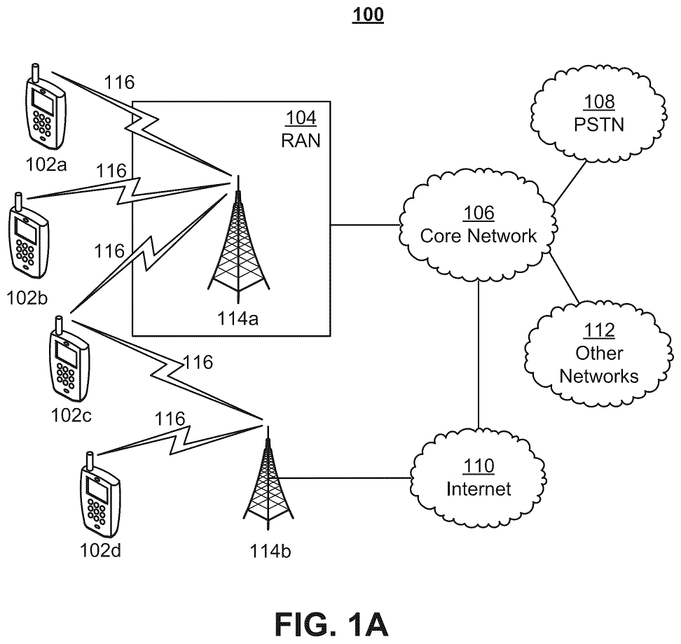

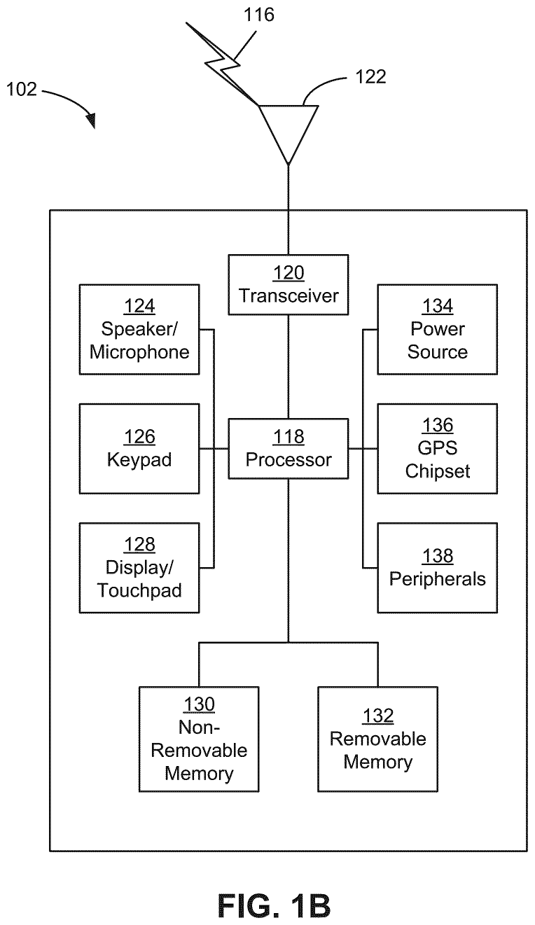

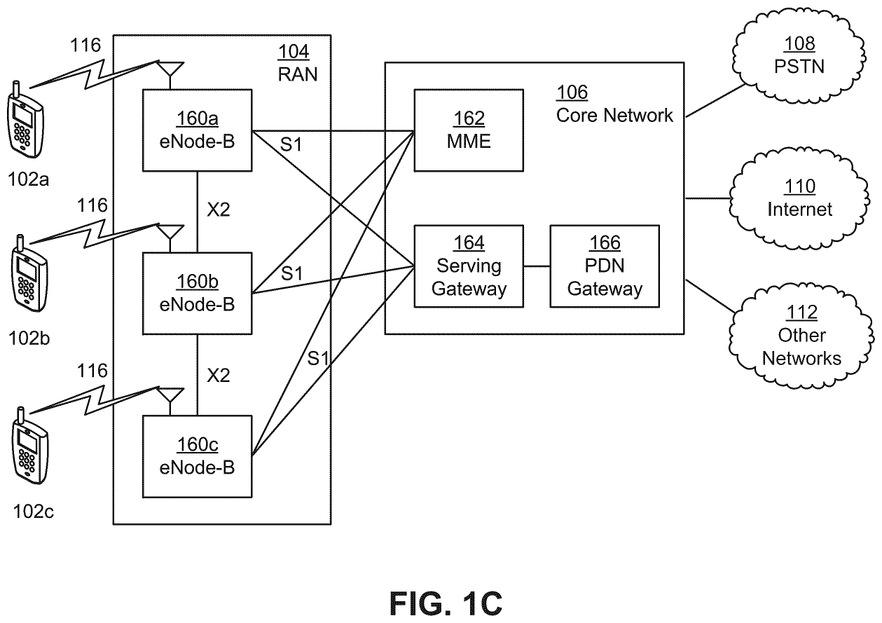

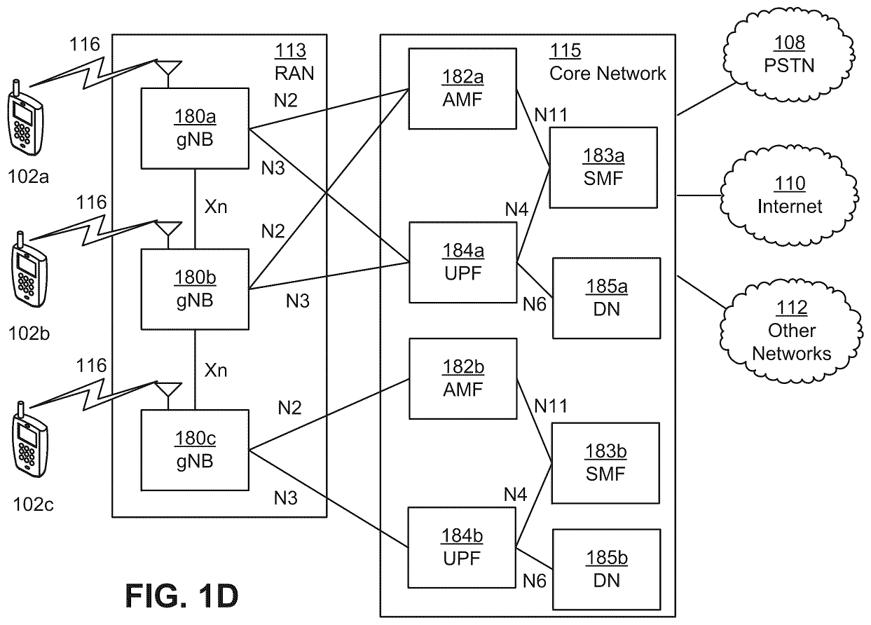

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

Systems, methods, and instrumentalities are disclosed for mapping multiplexed media identification information between a media application and network functions. A device (e.g., a wireless transmit/receive unit (WTRU) and/or an application server (AS)) may be provided including a processor. The device may identify one or more identifiers associated with one or more media flows of an application flow of a protocol data unit (PDU) session. The device may send, to a network, a request message including one or more sets of media identification information parameters associated with the one or more media flows. Each set of the one or more sets of media identification information parameters may indicate one of the one or more identifiers corresponding to a respective media flow. The request message may indicate at least one of a quality of service (QoS) rule or a charging policy to be applied to the respective media flow. The device may receive, from the network, the one or more media flows based on the corresponding at least one of the QoS rule or the charging policy.

In examples, the one or more identifiers may be source description (SDES) real-time protocol (RTP) compact header extension identifiers or one or more media identifiers (MIDs) to be used in the PDU session. The device may be configured to identify the one or more identifiers using session description protocol (SDP). In examples, each set of the one or more sets of media identification information parameters may indicate at least one or more of: a synchronization source (SSRC) identifier to be used by an RTC endpoint, a payload type to be used by the RTC endpoint, an identification-tag or media identifier to be used by an RTC endpoint, a local identifier associated with one of the one or more media flow(s), or a real-time transport control protocol (RTCP) packet type. In examples, one of the SSRC identifier, the payload type, the identification-tag or media identifier, or the local identifier may be negotiated using session description protocol (SDP). In examples, the one or more sets of media identification information parameters may be included within an application flow description or media transport parameters property of the application flow description.

In examples, the request message may be sent to an application function (AF) of the network. In examples, the device (e.g., the WTRU) may receive one or more media flows via a radio access network (RAN) node of the network.

If an application server is transmitting PDU sets data belonging to different media streams in a multiplexed flow (e.g., over a single QoS flow or multiple QoS flows), the UPF may need to identify the PDU sets belonging to the respective media streams (e.g., for differentiated QoS handling). Examples herein may be provided to identify the PDU sets belonging to different media streams present in a PDU session at the UPF.

Examples herein extend the dynamic policy information (e.g., which may include the application flow description and protocol description details) to include media identification information details about at least one of an SSRC, a payload type, an MID, a local Identifier (ID) of RTP SDES header extension (HE) (e.g., for MID), or a packet type of the various media streams present in a multiplexed application flow transmitted in a PDU session a multiplexed application flow transmitted in a PDU session, so that the UPF can associate the PDU sets in a multiplexed QoS flow to the respective media streams. Examples are described herein related to mapping the multiplexed media identification information details available in the media AF to NEF or PCF using the AFsessionWithQoS or PolicyAuthorization services respectively. An MID may be a media identifier, a media description identifier, or a media stream identifier herein.

At least one of the following control plane signaling examples may be used to map the multiplexed PDU sets to different media streams: a procedure for mapping the multiplexed media (e.g., PDU sets) to different media streams using the MID information present in the SDES RTP HE; signaling the SDES RTP HE information or the media stream identifier information in the control plane from media client to UPF via media AF and PCF/NEF to identify the PDU sets belonging to different media streams in UPF; or mapping the multiplexed media identification information present in the media AF to NEF or PCF using the AFsessionWithQoS or PolicyAuthorization services respectively.

Features described herein may be associated with RTP multiplexing. RTP may rely on UDP multiplexing for carriage of different media streams (e.g., using different UDP ports for each stream and RTCP). In examples, RTP-based multiplexing may be utilized to transport multiple media streams in cases where using additional UDP ports may not be feasible. For RTP multiplexing of streams in a single RTP session, an SSRC may be used. Combining RTCP and RTP on the same port may be referred to as RTP/RTCP multiplexing. The RTP and RTCP traffic may be multiplexed and/or demultiplexed using the shared second byte of the UDP payload (e.g., the RTCP packet type and the RTP M bit & RTP payload type). In WebRTC, the same port may be used for RTP, RTCP and/or different streams.

Other forms of multiplexing may be used to support carriage of different streams over RTP that have been popular in the media industry (e.g. MPEG-2 based multiplexing). For example, over RTP, the small TS packets of 188 bytes may be interleaved in an RTP packet. An RTP packet may include multiple small transport stream packets that may be audio, video, or even metadata related to a television program. This may lead to RTP packets including multiple media types.

The media streams may be transmitted as multiple RTP streams in a single RTP session, in multiple RTP sessions, or in some cases, multiplexed media may be carried in a single RTP stream. A media stream may be split into multiple QoS flows or multiple media streams may be multiplexed into a single QoS flow. Examples of the UPF and RAN nodes identifying PDU sets belonging to a specific media stream in a PDU session in the case of multiplexed media streams data flow are provided herein.

In RTP, different streams typically use different multiplexing methods for the delivery of the media streams. Given that a QoS flow is composed of PDUs from multiple media streams, the traffic over one QoS flow may be a mix of traffic from different media streams. PDU sets arriving at the UPF and RAN nodes may be from different streams, hence the UPF and RAN nodes may need to identify the respective media streams to which they belong.

Some mappings of streams to QoS flows may result in media streams that are split across one or more QoS flows. If media stream data is split across multiple QoS flows, some PDU sets of the stream may go over one QoS flow and some may go over other QoS flow. The UPF and RAN nodes may need to handle PDUs arriving at the UPF and NG RAN with missing PDU sets in a specific QoS flow.

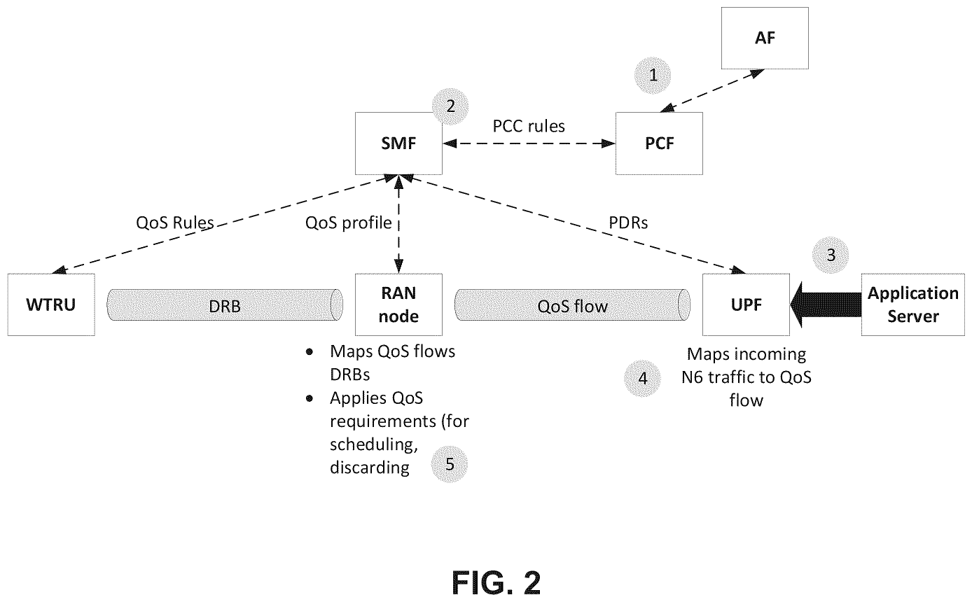

Features described herein may be associated with QoS management in a system (e.g., a 5G system). In an example system, QoS management may be based on QoS flows. PDUs (e.g., all PDUs) in a QoS flow may receive the same treatment in the RAN and in the UPFs in the core network. The QoS flow may be the finest granularity of QoS differentiation in the PDU session. A QoS flow may have one or more of the following QoS requirements: 5QI (including resource type, priority level, PDB, PER, averaging window, maximum data burst volume), ARP, RQA, notification control, flow bit rates (MFBR, GBR), aggregate bit rates, or maximum packet loss rates. The overall procedure to enable QoS management in the system is shown in FIG. 2 and described herein.

FIG. 2 illustrates an example QoS management in an example system (e.g., a 5G system). In FIG. 2, at 1, the application function (AF) may provision the network (e.g., PCF) with QoS requirements of the traffic flows, for example, using a network exposure function (NEF) service API such as Nnef_AFsessionWithQoS_Create. In FIG. 2, at 2, QoS information may be used by the PCF to configure PCC rules. Based on the rules configured in the PCF, the SMF may configure the RAN node with a QoS profile, the UPF with PDRs, and the WTRU with QoS rules. In FIG. 2, at 3, a PDU may arrive at the UPF (e.g., over the N6 interface). In FIG. 2, at 4, using the configured PDRs, the UPF may map the traffic to a QoS flow. The UPF may create a tunnel to the RAN node and send the arriving PDU to the RAN node in a GTP-U packet. In FIG. 2, at 5, the RAN node may use the configured QoS profile to determine how to manage the GTP-U packet. This management may include how to schedule the packet to the WTRU and whether the packet should be discarded. If scheduled, the packet may be transmitted to the WTRU on a configured data radio bearer (DRB).

Additional processing may be associated with XR media traffic. For example, the XR traffic may be transmitted as PDU sets. The QoS profile may have requirements that target PDU sets. The header of the GTP-U PDU may carry PDU set information.

A single XR stream may be mapped to a QoS flow. Features described herein may be associated with PDU set handling. To support PDU set based QoS handling, the PSA UPF may identify PDUs that belong to PDU sets and determines PDU set Information which it sends to the NG-RAN in the GTP-U header. The PDU set information may be used by the NG-RAN for PDU set based QoS handling.

The PDU set information may include one or more of the following: a PDU set sequence number, an indication of end PDU of the PDU set, a PDU sequence number within a PDU Set, a PDU set size in bytes, or PDU set importance, which may identify the relative importance of a PDU set compared to other PDU sets within a QoS flow.

To determine the PDU set information, the PSA UPF may rely on information carried in the received packets and/or on implementation. For example, if the XRM traffic is carried over RTP, the RTP header may include one or more of the following:

The RTP header may include an end PDU of the PDU set [E] (1 bit): this field may be a flag that is set to 1 for the last PDU of the PDU set and set to 0 for (e.g., other) PDUs of the PDU set.

The RTP header may include an end of data burst [EDB] (3 bits): The EDB field may be 3 bits in length and may indicate the end of a data burst. The 3 bits may encode the end of data burst indication as per the encoding and guidelines described herein.

The RTP header may include a PDU set importance (PSI) (4 bits): The PDU set importance field may indicate the importance of this PDU set compared to other PDU sets within the same QoS flow. Lower values may indicate a higher importance PDU set, with the highest importance PDU set indicated by 0 and the lowest importance PDU set indicated by 15.

The RTP header may include a PDU set sequence number (PSSN) (10 bits): The field may encode the sequence number of the PDU set to which the current PDU belongs acting as a 10-bit numerical identifier for the PDU set.

PDU sequence number within a PDU set (PSN) (6 bits): The sequence number of the current PDU within the PDU set. The PSN may be set to 0 for the first PDU in the PDU set and incremented monotonically for a PDU in the PDU set in order of transmission from the sender.

The RTP header may include a PDU set size (PSSize) (24 bits): The PDU set size may indicate the total size of PDUs of the PDU set to which this PDU belongs. This field may be optional and subject to an SDP signaling offer/answer negotiation, where the application server (AS) may indicate whether it will be able to provide the size of the PDU set for that RTP stream. If not enabled, the field may not be present. If enabled, and the AS is unable to determine the PDU Size for a particular PDU set, it may be set to 0 in PDUs of that PDU set. The PSSize may indicate the size of a PDU set including RTP/UDP/IP header encapsulation overhead of its corresponding PDUs. The PSSize may be expressed in bytes.

The network may be configured with PDU set QoS requirements (or information). This information may be associated per QoS flow, and as a result, the PDU set QoS requirements may be the same for (e.g., all) PDU sets carried in a QoS flow. One or more of the following PDU set QoS requirements may be associated with XRM traffic flows: PDU set delay budget (PSDB): The PSDB may indicate an upper bound for the delay that a PDU set may experience for the transfer between the WTRU and the N6 termination point at the UPF, e.g., the duration between the reception time of the first PDU (at the N6 termination point for DL or the WTRU for UL) and the time when all PDUs of a PDU set have been successfully received (at the WTRU for DL or N6 termination point for UL); PDU set error rate (PSER): The PSER may indicate an upper bound for the rate of PDU sets that have been processed by the sender of a link layer protocol (e.g. RLC in RAN of a 3GPP access) but that may not be successfully delivered by the corresponding receiver to the upper layer (e.g. PDCP in RAN of a 3GPP access); or PDU set integrated handling information (PSIHI): The PSIHI may indicate whether all PDUs of the PDU set are needed for the usage of the PDU set by the application layer in the receiver side.

PDU set traffic characteristics may be provided by the core network to the NG-RAN to configure WTRU power saving management scheme for connected mode DRX. The PDU set traffic characteristics may include: UL and/or DL periodicity; N6 jitter information associated with the DL periodicity; or indication of end of data burst.

The UL and/or DL periodicity and N6 jitter information associated with the DL periodicity may be provided by the core network to NG RAN via TSCAI. The core network may get this information from the AF, or it may derive some of these at the UPF. The information may be transferred to the NG RAN via the SMF and AMF. Features described herein may be associated with multiplexed streams.

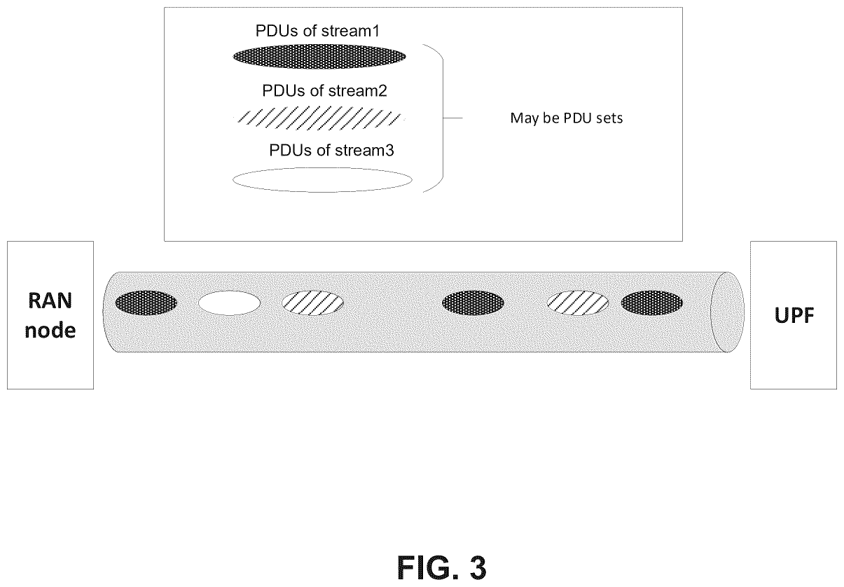

FIG. 3 illustrates an example of multiplexed streams. XR media services may include multiple types of flows, e.g., video streams, audio stream, haptic, other metadata, or sensor data for more immersive experience. To enable these immersive services, media types data may be multiplexed into a single data flow before arriving at the system ingress (e.g., 5GCS ingres). A stream may have its own PDU set properties. The QoS flow may carry multiplexed streams (e.g., as illustrated in FIG. 3). Various multiplexed streams may have different QoS characteristics, periodicities, and/or PDU set properties.

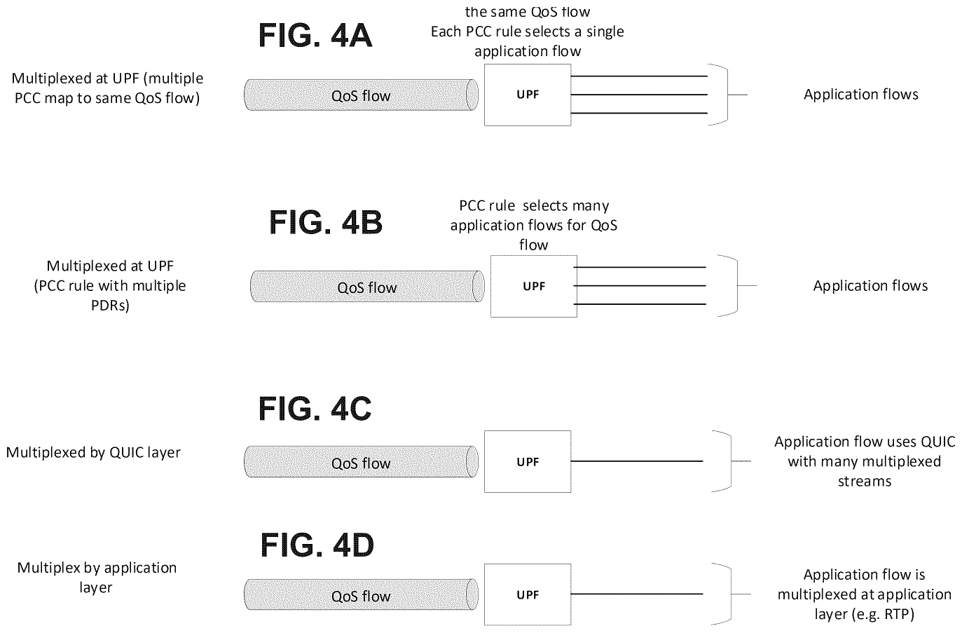

FIGS. 4A-4D illustrate various examples of how multiplexed streams may be created. As illustrated in various examples provided in FIGS. 4A-4D, multiplexing of the XR streams may occur at one or more of the following: at an application layer e.g. RTP (e.g., as illustrated in FIG. 4D), at a transport layer (e.g., QUIC) (e.g., as illustrated in FIG. 4C), based on PCC rules provided to UPF (e.g., as illustrated in FIGS. 4A and 4B). As illustrated in FIG. 4A, the QoS flow may be multiplexed at an application layer where multiple PCC points may point to the same QoS flow. In such an example, each PCC rule may select a single application flow. As illustrated in FIG. 4B, the QoS flow may be multiplexed at an application layer where a PCC rule may select many application flows for a QoS flow.

As illustrated in FIG. 4C, an application flow may use (e.g., be multiplexed by) a transport layer (e.g., a QUIC layer). As illustrated in FIG. 4C, the application flow may use QUIC with many multiplexed streams.

As illustrated in FIG. 4D, an application flow may be multiplexed at an application layer (e.g., RTP). Features described herein may be associated with how to identify multiplexed traffic flows with different QoS requirements within a single transport connection; how to do QoS Flow mapping for traffic flows with different QoS requirements; whether and what information may be provided from AF for traffic detection; or whether and how an AF may provide QoS requirements of different traffic flows to the system.

Various multiplexing options may be provided to map SDFs to QoS flows. For example, in multiplexing option1, one SDF stream per QoS flow may be provided. In multiplexing option2, M SDF streams may be provided per QoS flow. In multiplexing option 2, M streams may have the same QoS parameters and PDU set QoS parameters and similar PDU set traffic characteristics. In multiplexing option3, M SDF streams per QoS flow may be provided. In multiplexing option 3, M streams may have the same QoS parameters and PDU set QoS parameters and may have different PDU set traffic characteristics. In multiplexing option4, M SDF streams per QoS flow may be provided. In multiplexing option4, M streams may have the same QoS parameters, different PDU set QoS parameters, and different PDU set traffic characteristics. M streams may have PDU set QoS parameters that are the same and that are different. In multiplexing option5, parts of N SDF streams may be mapped to a QoS flow. In multiplexing option5, the N streams may have the same QoS parameters and one or more PDU Set QoS parameters (e.g., the N streams may have the same PSI). The N streams may have the same or different PDU set characteristics.

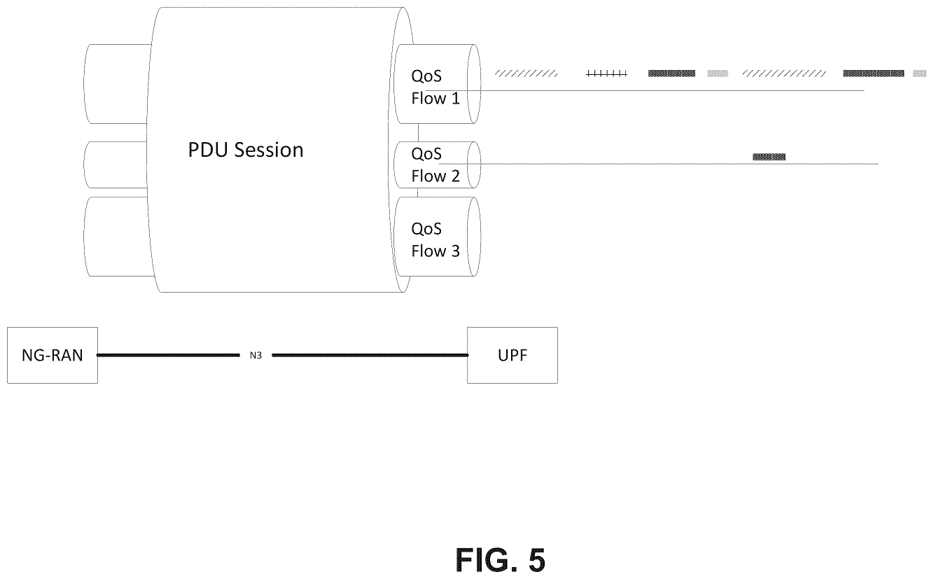

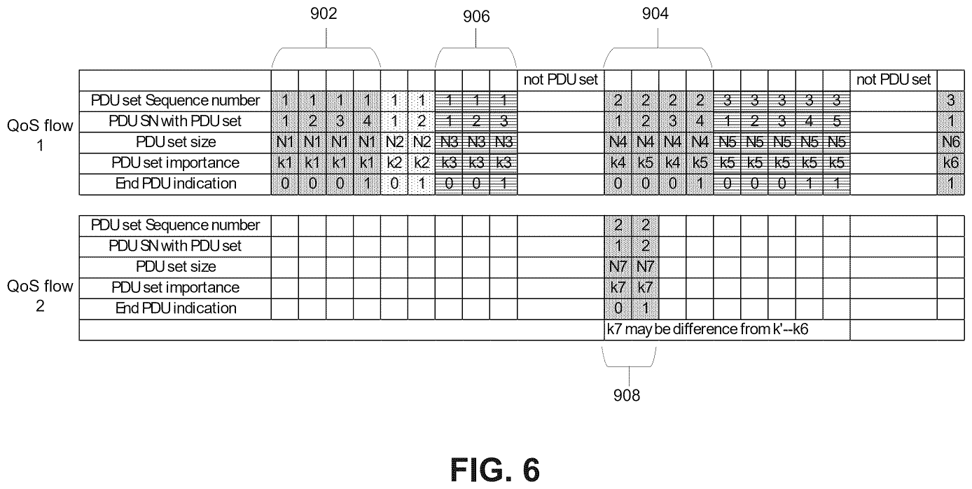

FIG. 5 illustrates an example of traffic over QoS flows with multiplexing Option4 or multiplexing Option5. FIG. 6 illustrates an example of PDU Set information that may be carried in example QoS flows. As illustrated in FIG. 6, all PDUs sets associated with a stream (902, 904) may be included in the QoS flow 1, while PDU sets associated with another stream (906, 908) may be split across the QoS flow 1 and the QoS flow 2.

Features described herein may be associated with identifying the media streams in a multiplexed QoS flow. In examples, the media streams may be identified using information provided in SDES RTP compact header extension. In examples, if multiple RTP streams are associated and multiplexed into a single RTP session, these RTP streams may be grouped together (e.g., called a BUNDLE). SDP BUNDLE framework may be provided using an SDP offer/answer exchange to negotiate the “m=” sections that may become part of a BUNDLE group. In this framework, each “m=” section may be associated with its identification-tag (e.g., the values of “mid” attribute). A BUNDLE group may be defined as the SDP ‘group:BUNDLE’ attribute having identification-tag list. RTP-based media (e.g., all RTP-based media) within a single BUNDLE group may belong to a single RTP session. “m=” sections representing RTP-based media within a BUNDLE group may share a single SSRC numbering space. Additional rules and/or restrictions to be applied on an RTP session may be provided.

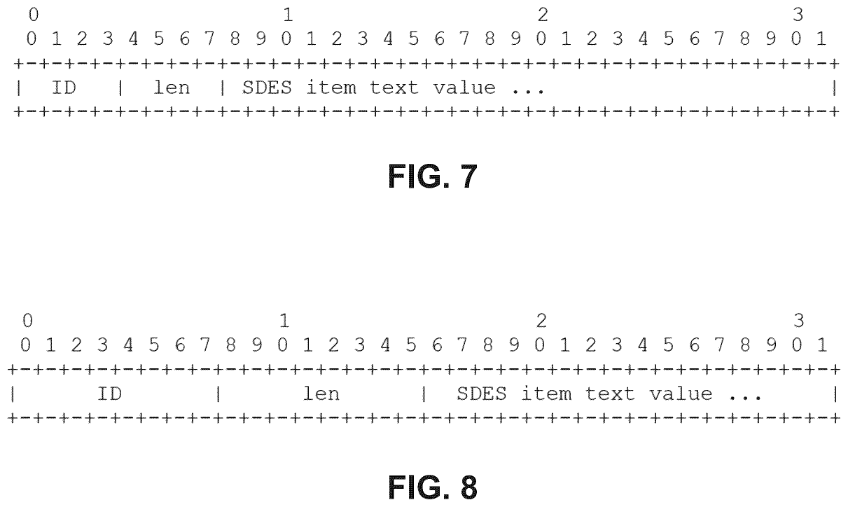

FIG. 7 illustrates a one-byte header extension format for SDES items. FIG. 8 illustrates a two-byte header extension format for SDES items. An RTP header extension method may be provided for the SDES items. FIG. 7 and FIG. 8 show the format of 1-byte and 2-byte SDES item extended headers, respectively. The MID RTP HE may be defined and/or registered by IANA in the “RTP SDES compact header Extensions” sub-registry and carrying the identification-tag of the associated “m=” section. The MID RTP HE may enable a receiver to associate each RTP stream with a specific “m=” section.

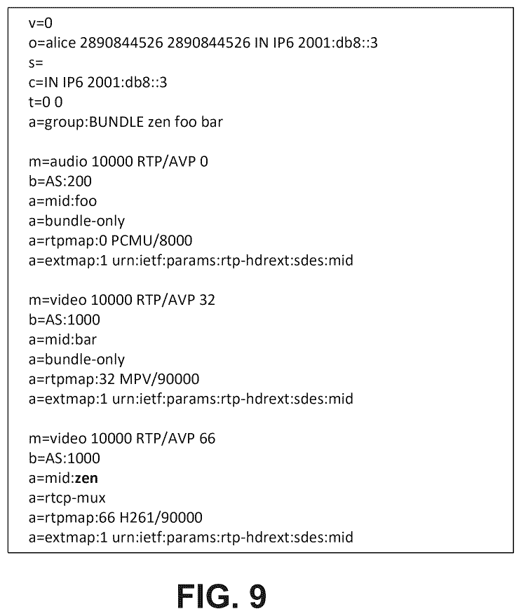

FIG. 9 shows an example of SDP for bundled media streams where the answerer may accept the creation of the bundle group. As illustrated in FIG. 8, multiple (e.g., three) RTP media streams may be bundled together by announcing “a=group:BUNDLE” group. Media stream(s) (e.g., each media stream) may be identified by using “a=mid:XXX” attribute.

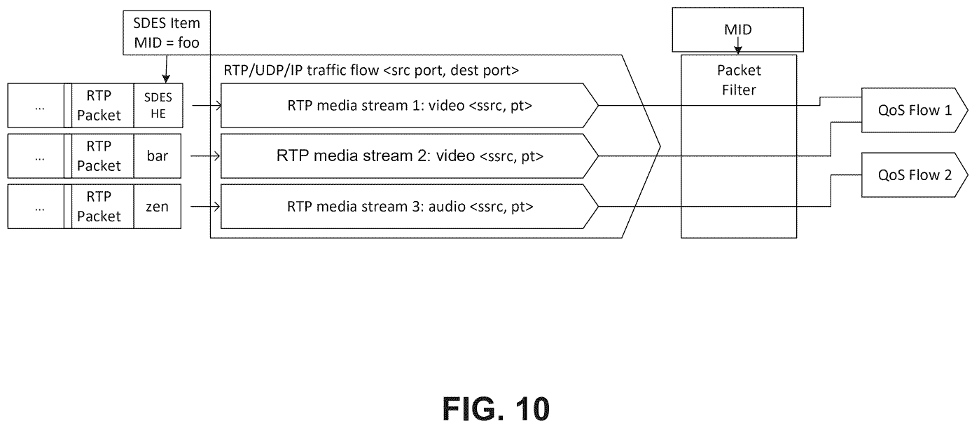

A MID value, which may be exchanged in an SDP negotiation, may be inserted into the extended header of each RTP packet. The MID value may be used to identify how each of the RTP packets are associated with the RTP media stream. FIG. 10 illustrates the QoS mapping structure using a MID packet filter which may map video stream(s) (e.g., RTP media streams 1 & 2) to QoS flow 1 and an audio stream (e.g., RTP media stream 3) to QoS flow 2, respectively.

Features described herein may utilize RTP SDES HE URI in SDP messages for negotiation, for example. The extension URI may be defined in the “RTP SDES compact header extensions” sub-registry of the “RTP compact header extensions” sub-registry. An extension URI may be urn:ietf:params:rtp-hdrext:sdes:mid and a description may be a media identification.

The SDES item may not reveal privacy information about the users. It may be used to associate RTP-based media with the correct SDP media description (“m=” section) in the SDP used to negotiate the media.

A dynamic policy API may be provided, for example, to allow the media client or ICE function of the media application server (AS) or the webRTC signaling function of the media AS to request a specific QoS policy and/or charging policy to be applied to the application flows of a media session. The dynamic policy API may be invoked (e.g., as a result of SDP negotiation during the webRTC signaling phase of a media session).

If a specific QoS with PDU set parameters is desired, and PDU set marking is not enabled for the selected policy template, the media client and/or the WTRU may populate (e.g., additionally populate) the media TransportParameters property of the Application FlowDescription object as follows, for example, when creating or updating a dynamic policy instance based on that policy template. The transportProto property may be set to the value SRTP. The rtpHeaderExtInfo object may be omitted. The rtpPayloadInfoList property may include a single member populated. rtpPayloadTypeList may be set to the RTP payload type value(s) to be used by the RTC endpoint (e.g., the RTC access function of an RTC client) for the negotiated SRTP session(s) to be carried by the application flow in question. rtpPayloadFormat may be populated as appropriate in the absence of RTP header extensions.

If PDU set marking is enabled for the selected policy template, the media client may populate (e.g., additionally populate) the mediaTransportParameters property of the Application FlowDescription object when creating or updating a dynamic policy instance based on that policy template. The transportProto property may be set to the value SRTP. The properties of the rtpHeaderExtInfo object may be populated. rtpHeaderExtType may be set to PDU_SET_MARKING. rtpHeaderExtId may be set to the value of the ID field to be used by the RTC endpoint (e.g., the RTC access function of an RTC client) in the RTP header extension for PDU set marking on the application flow in question. The value of rtpHeaderExtId may be negotiated via the SDP offer/answer exchange during the WebRTC signaling phase of the RTC session. The parameter longFormat may be set according to the use of the one- or two-byte RTP Header Extension for PDU Set Marking. The value of the longFormat parameter may be negotiated via the SDP offer/answer procedure during the WebRTC signaling phase of the RTC session. The parameter pduSetSizeActive may be set to reflect the presence of the PDU set size field in the RTP header extension for PDU set marking. The value of the pduSetSizeActive parameter may be negotiated via the SDP offer/answer procedure during the webRTC signaling phase of the RTC session. The intention of the RTC access function of the RTC client to include the optional NPDS (e.g., number of PDUs in the PDU set) field in the RTP Header Extension for PDU Set Marking may not be signaled in advance to the 5G Core by means of a Boolean flag in the RtpHeaderExtInfo. The rtpPayloadInfoList property may include a single member populated. rtpPayloadTypeList may be set to the RTP payload type value(s) to be used by the RTC endpoint (e.g., the RTC access function of an RTC client) for the negotiated SRTP session(s) to be carried by the application flow in question. rtpPayloadFormat may be omitted because RTP header extensions are present.

In PDUs (e.g., all PDUs) that fall within the scope of the application flow description, the media access function may use the protocol indicated in transportProto. The SRTP header fields may be set in accordance with rtpPayloadInfoList. The media access function may include a one- or two-byte (e.g., consistent with the signaled length) RTP HE for PDU set marking in the SRTP header with fields set according to the values declared in the rtpHeaderExtInfo property.

In examples, PDU sets may arrive at the UPF and/or RAN nodes of the system (e.g., 5G system) from different media streams. The PDU set information carried in these PDUs may not be correlated. If the application server is transmitting PDU sets with data belonging to different media streams in a multiplexed flow (over a single QoS flow or multiple QoS flows), the UPF may need to identify the PDU sets belonging to the respective media streams, for differentiated QoS handling.

The UPF and/or the NG RAN may keep track of the PDU sets arriving from different media streams using the identification-tag (e.g., the values of “mid” attribute) present in the SDES RTP HE and/or a synchronized source (SSRC) identifier. To identify PDUs or PDU sets belonging to a media stream, the UPF and/or NG RAN may need to know one or more SDES RTP HEs for MID, MIDs, SSRCs used in the application flow or PDU/RTP session.

Dynamic policy information (e.g., which includes the protocol description details) API may be extended to include details about various SDES RTP HE IDs used in a PDU session transmitting multiple media streams, so that at least one of the following may occur: a media client or media AS may understand the list of SDES RTP HE IDs used in the media streaming session; a media client or media AS may identify the list of media stream identifiers or identification-tags present in the multiplexed traffic using the SDES RTP HEs; a media client or media AS may create a dynamic policy instance with the multiplexed media identification information for media stream(s) (e.g., each media stream) in an application flow; a media application flow may map the multiplexed media identification such as SSRC, SDES RTP HE for MID and MID(s) of media stream(s) (e.g., each media stream) in an application flow to the corresponding multiplexed media identification information in the Npcf_PolicyAuthorization or Nnef_AFsessionWithQoS services; a PCF or NEF may provide multiplexed media identification information details to the UPF in an SDF filter; or a UPF may associate the PDU sets present in a multiplexed QoS flow data to the respective media stream(s). Identifying the list of media stream identifiers or identification-tags present in the multiplexed traffic may include identifying one or more identifier(s) (e.g., source description (SDES) real-time protocol (RTP) compact header extension identifiers or one or more media identifier(s) associated with one or more media flow(s) of an application flow of a protocol data unit (PDU) session (e.g., using session description protocol (SDP)).

Features described herein may include mechanisms utilized for mapping multiplexed media to media streams.

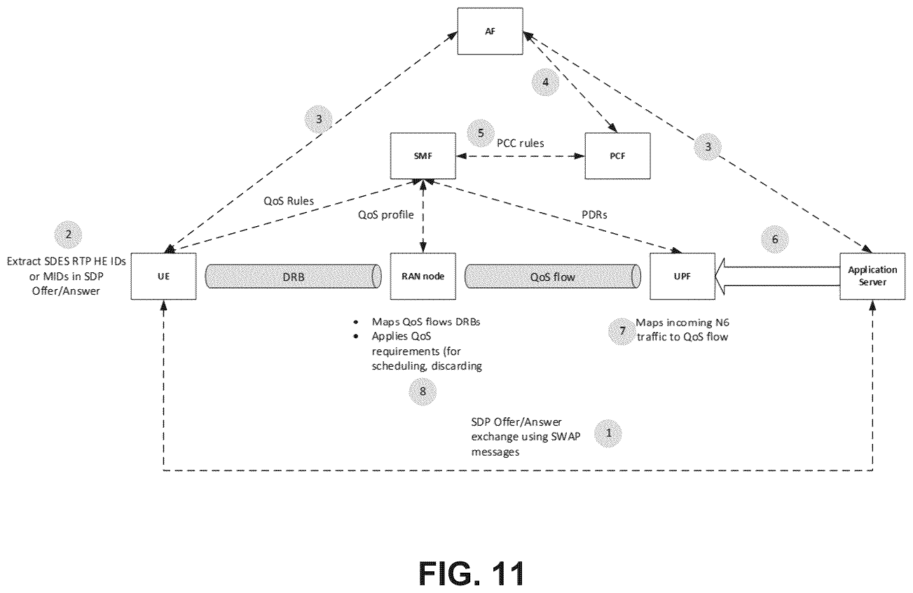

FIG. 11 illustrates mapping multiplexed media to respective media streams. The overall procedure to enable extended QoS management in the system (e.g., 5GS) to identify the multiplexed media flow data to the respective media streams is shown in FIG. 11.

In FIG. 11, at 1, an application server (AS) or interactive connectivity establishment (ICE) function of the media application server (AS) may exchange SDP offer/answer information (e.g., over SWAP messages to a WTRU during the WebRTC signaling phase of the media session).

In FIG. 11, at 2, a device (e.g., the WTRU and/or the AS) may identify the SDES RTP compact header extension IDs or the media identifiers (MIDs) or identification-tags (e.g., associated with one or more media flow(s)) used in a PDU session (e.g., of an application flow of a PDU session) using SDP (e.g., by extracting the “urn:ietf:params:rtp-hdrext:sdes:mid” attributes or “mid” attributes respectively present in the SDP offer/answer messages (e.g., an SDP message exchange)).

In FIG. 11, at 3, an RTC media session handler of the RTC client (e.g., the WTRU), the ICE function of the RTC AS, or the webRTC signaling function of the RTC AS may request a specific QoS and/or charging policy to be applied to the application flows of a PDU session using the dynamic policy API associated with the media application function (AF). The ApplicationFlowDescription object may be extended to include a media transport parameter property (e.g., mpxMediaInfos), which may provide details of SDES RTP header extensions for MID or the media stream IDs information. In examples, a request message (e.g., HTTP GET/PUT/POST message(s) associated with a RESTful operation) including one or more sets of media identification information parameter(s) associated with the one or more media flow(s) may be sent by the device (e.g., the WTRU and/or AS) to the network (e.g., the AF of the network). Set(s) (e.g., each set) of the one or more set(s) of media identification information parameter(s) may indicate one or the one or more identifier(s) corresponding to a respective media flow. Set(s) (e.g., each set) of the one or more set(s) of media identification information parameters may indicate at least one or more of: a synchronization source (SSRC) identifier to be used by an RTC endpoint, a payload type to be used by the RTC endpoint, an identification-tag or media identifier associated to be used by an RTC endpoint, a local identifier associated with one or more media flow(s), or a real-time transport control protocol (RTCP) packet type. In examples, one or the SSRC identifier, the payload type, the identification tag or media identifier, or the local identifier may be negotiated using SDP. The request message may indicate at least one of a QoS rule or a charging policy to be applied to the respective media flow(s).

In FIG. 11, at 4, the AF of the network may provision the network (e.g., PCF of the network) with QoS requirements of the traffic flows. In examples, the PCF of the network may be provisioned using a NEF service API such as Npcf_PolicyAuthorization or Nnef_AFsessionWithQoS.

In FIG. 11, at 5, QoS information (e.g., the QoS rule). may be used by the network (e.g., the PCF of the network) to configure PCC rule(s). Based on the PCC rule(s) configured in the network (e.g., the PCF of the network), the SMF of the network may configure the RAN node with a QoS profile, the UPF of the network with PDRs, and the WTRU with QoS rules.

In FIG. 11, at 6, the PDUs may arrive at the network (e.g., the UPF of the network) over an interface (e.g., the N6 interface). The PDUs may be associated with various media streams.

In FIG. 11, at 7, using the configured PDRs, the network (e.g., the UPF of the network) may identify the PDU sets belonging to different media streams and map the media traffic to one or more QoS flow(s). The UPF of the network may create a tunnel to the RAN node of the network. The UPF of the network may send the arriving PDU to the RAN node of the network, for example, in a GTP-U packet.

In FIG. 11, at 8, the network (e.g., RAN node of the network) may use the configured QoS profile to determine how to manage the GTP-U packet. This management may include how to schedule the packet to the WTRU and/or whether the packet should be discarded. If scheduled, the packet may be transmitted to the WTRU on a configured data radio bearer (DRB). The device (e.g., WTRU and/or AS) may receive, from the network, the one or more media flow(s) (e.g., the WTRU may receive the one or more media flow(s) from the RAN node of the network).

Updates may be provided to the dynamic policy API. If multiple RTP streams are associated and/or multiplexed into a (e.g., a single) RTP session, to identify the PDU sets belonging to different media streams present in that RTP/PDU session, the dynamic policy API may be extended.

In examples, the Application FlowDescription object may include the media transport parameter property (e.g., mpxMediaInfoList property). The media transport parameter property may include one or more mpxMediaInfo objects. mpxMediaInfo object(s) (e.g., each mpxMediaInfo object) of the media transport parameter property of the ApplicationFlowDescription object may include the details of the SSRC (e.g., to be used by an RTC endpoint), payload type (e.g., to be used by the RTC endpoint), an ID of the SDES RTP compact HEs (e.g., used for MID), a media identification-tag or media identifier (e.g., MID) associated with the one or more media flow(s), and/or RTCP packet type of the media streams present in the RTP/PDU media session. The payload types, IDs of the RTP SDES HE (e.g., for MID) and the MIDs used in the RTP/PDU media session may be extracted from the SDP offer/answer messages exchanged between the media AS and the media client or WTRU. The SDP offer/answer may be exchanged during the webRTC signaling phase using the SWAP message(s).

The properties of the MpxMediaInfo object may be populated as follows.

ssrcId may be set to the SSRC value in the RTP Header to be used by the RTC endpoint (e.g., the RTC Access Function of an RTC client or the RTC AS) for a media stream in the negotiated SRTP session(s) to be carried by the application flow in question.

payloadType may be set to the RTP Payload Type value to be used by the RTC endpoint (e.g., the RTC Access Function of an RTC Client or the RTC AS) for a media stream in the negotiated SRTP session(s) to be carried by the application flow in question. The value of this parameter may be negotiated via the SDP offer/answer procedure during the WebRTC signalling phase of the media session.

rsiMid may be set to the value of the identification-tag or media description identifier (MID) present in the SDES RTP Header Extension for MID or the RTCP MID SDES Item for MID on the application flow in question. The value of this parameter may be negotiated via the SDP offer/answer procedure during the WebRTC signalling phase of the media session.

rsheMid may be set to the value of the local identifier or ID field to be used by the RTC endpoint (e.g., the RTC Access Function of an RTC Client or the RTC AS) in the SDES RTP Header Extension for MID on the application flow in question. The value of this parameter may be negotiated via the SDP offer/answer procedure during the WebRTC signalling phase of the media session.

rtcpPt may be set to the RTCP Packet Type (PT) value to be used by the RTC endpoint (e.g., the RTC Access Function of an RTC Client or the RTC AS) for the negotiated SRTP session(s) to be carried by the application flow in question.

In examples, multiple RTP streams may be multiplexed into a single RTP session. In such cases, the SDP offer/answer may include multiple SDES RTP Header Extension extensions for multiple media streams. In the SDP offer/answer, rtpHeaderExtType IE may be used to identify the ID of the RTP header extension. This rtpHeaderExtType IE may be same for media streams (e.g., all media streams) or the rtpHeaderExtType IE may be unique for media streams (e.g., each media stream).

PDUs (e.g., all PDUs) of a media flow may contribute at reference point RTC 4m or RTC 12 that fall within the scope of the application flow description, a sender as the RTC Access Function (Media Access Function), or the media function of the RTC AS may use the protocol indicated in transportProto. The sender may set the SRTP header fields in accordance with the payload type of the media. The sender may include an SSRC with fields set according to the values declared in the ssrcid or a one- or two-byte RTP SDES Header Extension for MID in the SRTP header with fields set according to the values declared in the rsiMid field of mpxMediaInfo property. The sender may set the MpxMediaInfo object in protocol description to indicate at least one of the SSRC, payload type, media description identifier (MID), ID of the RTP SDES Header Extension for MID, or the RTCP packet type information of a media stream present in the application flow in question.

In examples, multiple media flows may be multiplexed into a single application flow. In such cases, dynamic policy invoker may populate the mpxMediaInfos property with the media identification information parameters to be used by the network for traffic detection. mpxMediaInfo object(s) (e.g., each mpxMediaInfo object) of the ApplicationFlowDescription.mpxMediaInfoList property may represent the media identification information of media flow(s) (e.g., each media flow) present in the application flow in question.

The ApplicationFlowDescription data type may be extended (e.g., as shown in Table 1) to include the media identification properties of the media stream(s) that may be part of an application data flow during the course of a media delivery session. The ApplicationFlowDescription properties may be used to describe a service data flow to the network for the purpose of application traffic detection. The properties of the MpXMedaInfo object are provided in Table 2 below.

TABLE 1
Definition of type ApplicationFlowDescription

| Property name | Data type | Cardinality | Description |
|---|---|---|---|
| filterMethod | SdfMethod | 1 . . . 1 | The filtering method used to identify |
| | | | packets belonging to this application flow |
| | | | (see clause 7.3.4.2). |
| packetFilter | IpPacketFilterSet | 0 . . . 1 | Description of the application flow in terms |
| | | | of packet header field values (see below). |
| domainName | string | 0 . . . 1 | Description of the application flow in terms |
| | | | of the Fully-Qualified Domain Name |
| | | | (FQDN) of the Media AS targeted at |
| | | | reference point M4 (see below). |
| mediaType | MediaType | 0 . . . 1 | The type of media carried by this |
| | | | application flow (see NOTE 1). |
| mediaTransportParameters | ProtocolDescription | 0 . . . 1 | The set of media transport protocol |
| | | | parameters to be used by the 5G Core for |
| | | | the purpose of PDU Set identification and/or |
| | | | end of data burst detection on this |
| | | | application flow (see NOTE 2). |
| mpxMediaInfoList | array (MpxMediaInfo) | 0 . . . 1 | The Multiplexed Media Information for the |
| | | | Uplink or Downlink IP flows based on the |
| | | | application flow description. |
| | | | Each member of the array provides the |
| | | | media identification information details to |
| | | | uniquely identify each media flow of the |
| | | | multiplexed media. |
| | | | If present, the array shall contain at least |
| | | | one object. |

TABLE 2
Definition of type MpxMediaInfo

| Property name | Data type | Cardinality | Description |
|---|---|---|---|
| ssrcId | Uinteger | 0 . . . 1 | Contains the synchronization source |
| | | | identifier as defined in IETF RFC 3550. |
| payloadType | integer | 0 . . . 1 | Integer between and including 1 and 127. |
| | | | When present, this IE shall contain the |
| | | | Payload Type (PT) values in the RTP |
| | | | header of RTP packets as defined in |
| | | | IETF RFC 3550. |
| rsiMid | string | 0 . . . 1 | When present, this IE shall contain the |
| | | | identification-tag of RTCP MID SDES Item |
| | | | for MID as defined in clause 15.1 of |
| | | | IETF RFC 9143. |
| rsheMid | string | 0 . . . 1 | When present, this IE shall contain the local |
| | | | identifier of RTP SDES Header Extension |
| | | | for MID as defined in clause 15.2 of |
| | | | IETF RFC 9143. |
| rtcpPt | integer | 0 . . . 1 | Integer between and including 200 and 204. |
| | | | When present, this IE shall contain the |
| | | | Packet Type (PT) values of RTCP packets, |
| | | | as defined in IETF RFC 3550 |

In examples, the mpxMediaInfoList property may be present in the mediaTransportParameters property of the ApplicationFlowDescription object. The media TransportParameters property (e.g., of type ProtocolDescription) may be extended to include the multiplexed media identification information (e.g., as illustrated in Table 3 below).

TABLE 3
Definition of type ProtocolDescription

| Attribute name | Data type | P | Cardinality | Description |
|---|---|---|---|---|
| transportProto | MediaTransportProto | O | 0 . . . 1 | When present, this IE shall indicate the |
| | | | | transport protocol used by the media flow. |
| rtpHeaderExtInfo | RtpHeaderExtInfo | C | 0 . . . 1 | This IE shall be present if RTP or SRTP is |
| | | | | used and the RTP payload packets contains |
| | | | | a RTP Header Extension that can be used for |
| | | | | PDU Set identification and/or End of Data |
| | | | | Burst marking. |
| | | | | When present, this IE shall contain |
| | | | | information on the RTP header extension that |
| | | | | can be used for PDU Set identification and/or |
| | | | | End of Data Burst marking. |
| | | | | (NOTE 1) |
| rtpPayloadInfoList | array(RtpPayloadInfo) | O | 1 . . . N | When present, it shall contain RTP Payload |
| | | | | information for the RTP stream, which can be |
| | | | | used to derive the PDU Set information |
| | | | | and/or End of Data Burst marking. |
| | | | | (NOTE 1) (NOTE 2) |
| mpxMediaInfoList | array(MpxMediaInfo) | O | 0 . . . 1 | The Multiplexed Media Information for the |
| | | | | Uplink or Downlink IP flows based on the |
| | | | | application flow description. |
| | | | | Each member of the array provides the |
| | | | | media identification information details to |
| | | | | uniquely identify each media flow of the |
| | | | | multiplexed media. |
| | | | | If present, the array shall contain at least one |
| | | | | object. |

If the first Dynamic Policy is created by the Media Session Handler in a Media Client or RTC endpoint for a particular media delivery session, the media AF may create an AF application session context in the PCF responsible for the PDU Session corresponding to the M4 application flows indicated in the DynamicPolicy.application FlowBindings array.

In examples, an AF application session context may not exist at a media AF. In such cases, the media AF may use the Npcf_PolicyAuthorization_Create operation at reference point N5 (or, if deployed outside the Trusted DN, the equivalent Nnef_AFsessionWithQoS service operation) with the appropriate service information to create and provision an AF application session context (e.g., a new AF application session context). The information in the AppSessionContextReqData may be derived from the application flow descriptions in the dynamic policy Instance resource and/or the requested QoS.

The mapping of application flows listed in the DynamicPolicy.application FlowBindings array to media components and sub-components of the AF application session context may be implementation-dependent.

In examples, the multiplexed media identification feature may be supported. In such cases, MpxMediaInfo object(s) (e.g., each MpxMediaInfo object) of the MediaSubComponent.mpxMediaInfos property array of the MediaComponent.medSubComps object may be populated using the corresponding MpxMediaInfo object present in the ApplicationFlowDescription. mpxMediaInfoList property array.

The properties of the MpxMediaInfo object may be populated (e.g., by the media AF) as follows.

The ssrcId property may be set to the value of mpxMediaInfos.ssrcId.

The payloadType property may be set to the value of mpxMediaInfos.payloadType if the media subcomponent includes RTP packets.

The rsiMid property may be set to the value of mpxMediaInfos.rsiMid.

The rsheMid property may be set to the value of mpxMediaInfos.rsheMid.

The rtcpPt property may be set to the value of mpxMediaInfos.rtcpPt when the media subcomponent contains RTCP packets.

In examples, the multiplexed media identification information may be provided as part of the media TransportParameters property of the ApplicationFlowDescription object. In such a case, the MediaSubComponent. mpxMediaInfos property array of the MediaComponent.medSubComps object may be populated from the mediaTransportParameters.rtpHeaderExtInfo property with rtpHeaderExtType equals to SDES_INFORMATION as follows by the media AF.

The ssrcId property may be set to the corresponding value in RtpHeaderExtInfo.ssrcIdList.

The payloadType property may be set to the corresponding value in RtpHeaderExtInfo.rtpPayloadTypeList.

The rsiMid property may be set to the corresponding value in RtpHeaderExtInfo.midList.

The rsheMid property may be set to the corresponding value in RtpHeaderExtInfo.rtpHeaderExtId.

The rtcpPt property may be set to the value of RtpHeaderExtInfo.rtcpPt if the media subcomponent includes RTCP packets.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed is:

1. A device, comprising:
a processor configured to:
identify one or more identifiers associated with one or more media flows of an application flow of a protocol data unit (PDU) session;
send, to a network, a request message comprising one or more sets of media identification information parameters associated with the one or more media flows, wherein each set of the one or more sets of media identification information parameters indicates one of the one or more identifiers corresponding to a respective media flow, and wherein the request message indicates at least one of a quality of service (QoS) rule or a charging policy to be applied to the respective media flow; and
receive, from the network, the one or more media flows based on the corresponding at least one of the QoS rule or the charging policy.

2. The device of claim 1, wherein the one or more identifiers are source description (SDES) real-time protocol (RTP) compact header extension identifiers or one or more media identifiers (MIDs) to be used in the PDU session, and wherein the processor configured to identify the one or more identifiers comprises the processor being configured to identify the one or more identifiers using session description protocol (SDP).

3. The device of claim 1, wherein each set of the one or more sets of media identification information parameters indicates at least one or more of: a synchronization source (SSRC) identifier to be used by an RTC endpoint, a payload type to be used by the RTC endpoint, an identification-tag or media identifier to be used by an RTC endpoint, a local identifier associated with one of the one or more media flows, or a real-time transport control protocol (RTCP) packet type.

4. The device of claim 3, wherein one of the SSRC identifier, the payload type, the identification-tag or media identifier, or the local identifier is negotiated using session description protocol (SDP).

5. The device of claim 1, wherein the one or more sets of media identification information parameters are included within an application flow description or media transport parameters property of the application flow description.

6. The device of claim 1, wherein the processor being configured to send the request message comprises the processor being configured to send the request message to an application function (AF) of the network.

7. The device of claim 1, wherein the processor is configured to receive the one or more media flows from a radio access network (RAN) node of the network.

8. A method, comprising:
identifying one or more identifiers associated with one or more media flows of an application flow of a protocol data unit (PDU) session;
sending, to a network, a request message comprising one or more sets of media identification information parameters associated with the one or more media flows, wherein each set of the one or more sets of media identification information parameters indicates one of the one or more identifiers corresponding to a respective media flow, and wherein the request message indicates at least one of a quality of service (QoS) rule or a charging policy to be applied to the respective media flow; and
receiving, from the network, the one or more media flows based on the corresponding at least one of the QoS rule or the charging policy.

9. The method of claim 8, wherein the one or more identifiers are source description (SDES) real-time protocol (RTP) compact header extension identifiers or one or more media identifiers (MIDs) to be used in the PDU session, and wherein the method identifying the one or more identifiers comprises the method identifying the one or more identifiers using session description protocol (SDP).

10. The method of claim 8, wherein each set of the one or more sets of media identification information parameters indicates at least one or more of: a synchronization source (SSRC) identifier to be used by an RTC endpoint, a payload type to be used by the RTC endpoint, an identification-tag or media identifier to be used by an RTC endpoint, a local identifier associated with one of the one or more media flows, or a real-time transport control protocol (RTCP) packet type.

11. The method of claim 10, wherein one of the SSRC identifier, the payload type, the identification-tag or media identifier, or the local identifier is negotiated using session description protocol (SDP).

12. The method of claim 8, wherein the one or more sets of media identification information parameters are included within an application flow description or media transport parameters property of the application flow description.

13. The method of claim 8, wherein the request message is sent to an application function (AF) of the network.

14. The method of claim 8, wherein the one or more media flows are received from a radio access network (RAN) node of the network.

15. A device comprising:
a processor configured to:
receive a request message comprising one or more sets of media identification information parameters associated with the one or more media flows, wherein each set of the one or more sets of media identification information parameters indicates one of one or more identifiers corresponding to a respective media flow, and wherein the request message indicates at least one of a quality of service (QoS) rule or a charging policy to be applied to the respective media flow; and
send the one or more media flows based on the corresponding at least one of the QoS rule or the charging policy.

16. The device of claim 15, wherein the one or more identifiers are source description (SDES) real-time protocol (RTP) compact header extension identifiers or one or more media identifiers (MIDs) to be used in a PDU session, and wherein the processor configured to identify the one or more identifiers comprises the processor being configured to identify the one or more identifiers using session description protocol (SDP).

17. The device of claim 15, wherein each set of the one or more sets of media identification information parameters indicates at least one or more of: a synchronization source (SSRC) identifier to be used by an RTC endpoint, a payload type to be used by the RTC endpoint, an identification-tag or media identifier to be used by an RTC endpoint, a local identifier associated with one of the one or more media flows, or a real-time transport control protocol (RTCP) packet type.

18. The device of claim 17, wherein one of the SSRC identifier, the payload type, the identification-tag or media identifier, or the local identifier is negotiated using session description protocol (SDP).

19. The device of claim 15, wherein the one or more sets of media identification information parameters are included within an application flow description or media transport parameters property of the application flow description.

20. The device of claim 15, wherein the processor is configured to send the one or more media flows to a wireless transmit/receive unit (WTRU) via a radio access network (RAN) node of the network.
